(19) United States
(12) Patent Application Publication
(10) Pub. No.: US 2006/0082555 A1
(43) Pub. Date: Apr. 20, 2006

(54) Method of inputting character in mobile terminal

(76) Inventors: Yun-Kee Kang, Seoul (KR); Hoon-Kee Kang, Seoul (KR)

Correspondence Address: HARNESS, DICKEY & PIERCE, P.L.C., P.O. BOX 828, BLOOMFIELD HILLS, MI, 48303, US

(21) Appl. No.: 10/538,549

(22) PCT Filed: Aug. 20, 2004
(86) PCT No.: PCT/KR04/02105

§ 371 Date: Jun. 10, 2005

(30) Foreign Application Priority Data
Aug. 26, 2003 (KR) 10-2003-0059263

(51) Int. Cl. G09G 5/00

(52) U.S. Cl. 345/169

(57) ABSTRACT

A method of inputting letters in a wireless terminal is disclosed. The method comprises steps of: typing in at least a first and last letter of a word to be input, and pressing a function key, recognizing as the last letter of the word to be input a letter typed-in prior to pressing the function key, retrieving from a word repository words having the same first and last letters as the typed-in first and last ones, and displaying the retrieved words on a display device, selecting a desired word from the displayed words, and converting the typed-in first and last

### BACKGROUND OF THE INVENTION

1. Field of the Invention

The present invention relates to a method of inputting letters into a wireless terminal, in particular such a method, in which, if at least the first and last letters of a desired word are input into a wireless terminal, words matching the first and last letters are retrieved from a word repository, so that the desired word can be selected from the retrieved words.

2. Description of the Related Art

Conventionally, in order to input a word into a wireless terminal (for example, a cellular phone, a PDA, or the like), all the letters of the word from the first letter to the last one must be typed in order, so that it might result in typos, as well as a longer time for inputting a word. In case of a word consisting of many letters, for example, more than 6 letters in a word, the above inconvenience and disadvantages become more serious.

In order to cope with these problems in the art, as depicted in FIG. 6, a method has been proposed, in which, while inputting the letters of a word in sequence from the first one thereof, related words are retrieved in the alphabetic order. In this method, if letters are typed sequentially into a letter input area 42 from the first letter of a word to be input, the words that include the typed-in letters are displayed in a relevant word area 44, from which the user may select a word to input. As shown in the figure, when the user types English letter ‘abac’ into the letter input area 42 in order to input an English word ‘abaculus’, words starting with ‘abac’ (aback, abacterial, abaculus, abacus) are displayed in the relevant word area 44, among which the word ‘abaculus’ can be selected by the user.

However, this conventional method of inputting letters embraces a disadvantage in that, if letters, especially the English alphabet, are typed from the first one sequentially, too many similar words are displayed unnecessarily, and therefore a desired word cannot be quickly and easily input. That is, in general, there are few words that include the same first and last letters in English words. On the other hand, because there are too many words (e.g. aback, abacterial, abaculus, and abacus) which are similar in the front part thereof, unnecessary words are inevitably displayed together, and therefore it takes time to input a word.

Needless to say, these problems will arise in an electronic dictionary, a documentation program, and the like, along with a cellular phone, all of which adopt the same method of inputting letters.

### SUMMARY OF THE INVENTION

Therefore, the present invention has been made in order to solve the above problems, and it is an object of the invention to provide a method of inputting letters, in which, if only a first and last letters of a word to be input are typed in, words matching the first and last letters are retrieved from a word repository, thereby enabling a fast and easy input of words.

In order to accomplish the above object, according to the one aspect of the invention, there is provided a method of inputting letters in a wireless terminal. The method comprises steps of: a) typing in at least a first and last letters of a word to be input, and pressing a function key; b) recognizing as the last letter of the word to be input a letter typed-in prior to pressing the function key; c) from a word repository, retrieving words having the same first and last letters as the typed-in first and last ones and displaying the retrieved words on a display device; and d) selecting a desired word from the displayed words, and converting the typed-in first and last letters into the selected word.

In the above step c), the number of letters of a word to be retrieved may be restricted to within a certain predetermined range.

After pressing the function key, preferably a cursor may move to in front of the last letter so as to enable an additional letter to be input.

Preferably, among the retrieved words a word of high frequency is displayed on a higher position than other words.

If the function key is pressed N times after typing the last letter, all the letters from the n^{th} letter to the last one are recognized as the last letters.

According to another aspect of the invention, there is provided a method of inputting letters in a device capable of accepting letters as input. The method of the invention comprises steps of: a) typing in a first predetermined number of letters sequentially from a first letter of a word to be input, and pressing a function key; b) retrieving words starting with the typed-in letters, the retrieved words being composed of a second predetermined number of letters; c) displaying the retrieved words on a display device; and d) selecting a desired word from the displayed words, and converting the typed-in letters into the selected word.

The above device may include a cellular phone, a PDA, or a personal computer.

### BRIEF DESCRIPTION OF THE DRAWINGS

Further objects and advantages of the invention can be more fully understood from the following detailed description taken in conjunction with the accompanying drawings, in which:

FIG. 1 is a functional block diagram of a wireless terminal according to the invention;

FIG. 2 shows a screen configuration of a wireless terminal comprising a letter input area and a retrieved word area according to the invention;

FIG. 3 shows one example of target words to be retrieved;

FIG. 4 is a flow chart showing a method of inputting letters according to the invention;

FIG. 5 shows a screen configuration of a documentation window including a retrieved word area; and

FIG. 6 shows a screen configuration of a display of a conventional wireless terminal.

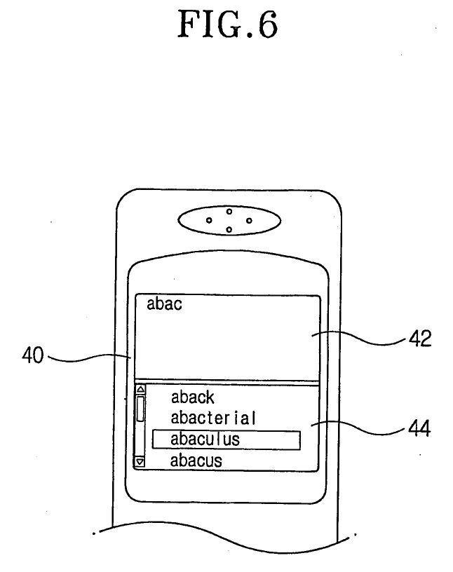

### DETAILED DESCRIPTION OF THE INVENTION

Hereafter, the preferred embodiments of the present invention will be explained in detail with reference to the accompanying drawings.

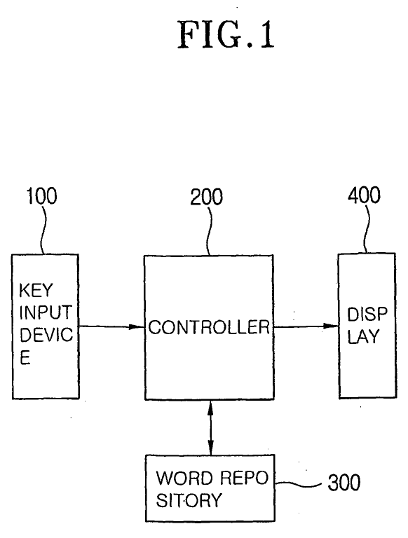

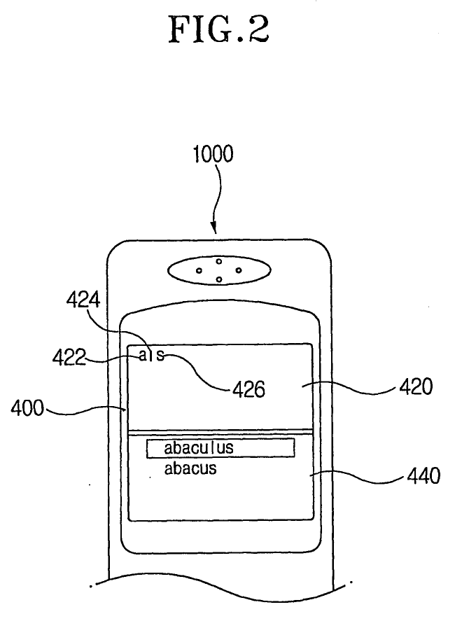

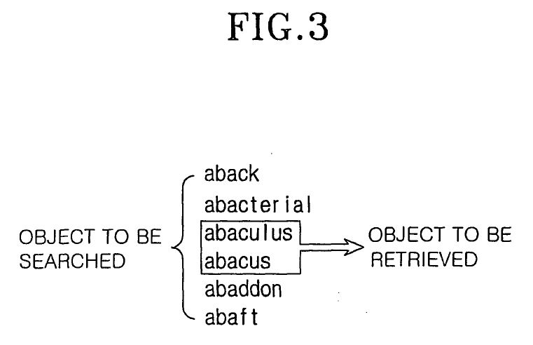

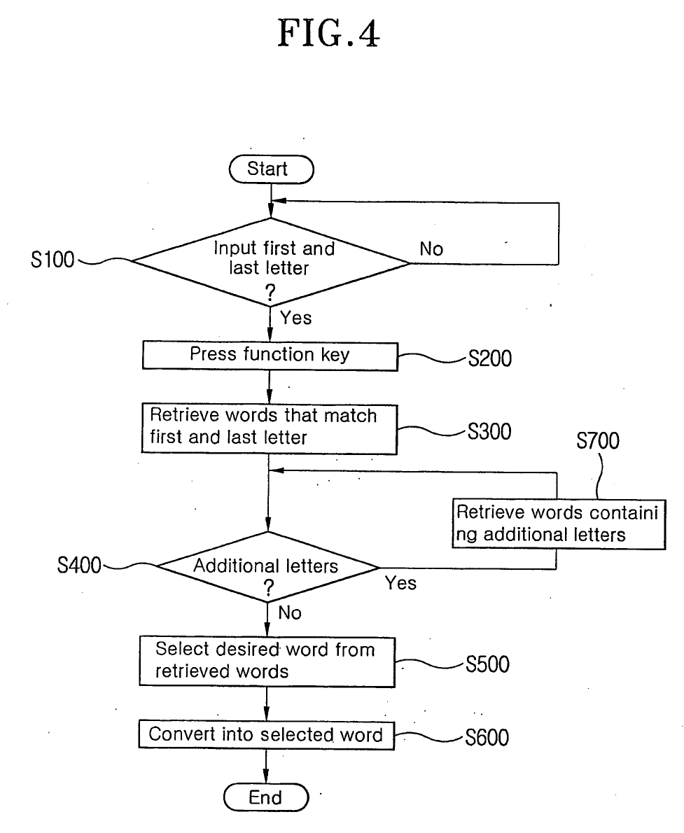

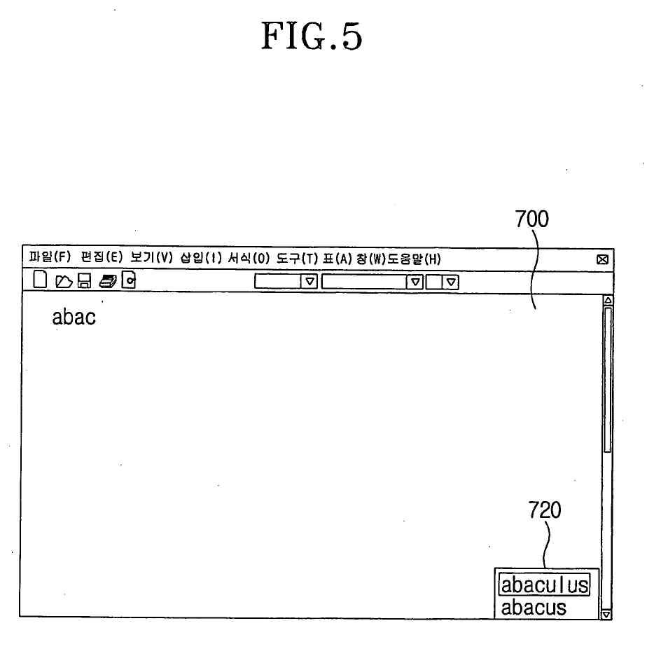

FIG. 1 is a functional block diagram of a wireless terminal according to the invention. FIG. 2 shows a screen configuration of a wireless terminal comprising a letter input area and a retrieved word area according to the invention. FIG. 3 shows one example of target words to be retrieved. FIG. 4 is a flow chart showing a method of inputting letters according to the invention. FIG. 5 shows a screen configuration of a documentation window including a retrieved word area.

As shown in FIG. 1, the wireless terminal according to the invention comprises a key input device 100, a controller 200, a word repository 300, and a display 400.

The key input device 100 includes numeric keys for inputting a desired letter and number, and function keys (#, *).

At the word input mode, when the first and last letters of a word to input is typed in through the key input device 100 and then a function key is pressed, the controller 200 recognizes the letter typed prior to the function key input as the last letter, and retrieves from the word repository 300 all the words having the same first and last letters as the typed-in ones.

Thousands or tens of thousands of words are stored in the word repository 300 depending on the storage capacity, and preferably the words may be classified according to the first and last letters so that relevant words can be retrieved by means of the first and last letters only.

The display 400 comprises a retrieved word area 440 as shown in FIG. 2, which will be described hereafter. The words retrieved by the controller 200 are displayed in the retrieved word area 440.

In the wireless terminal as described above, the display 400 may be configured as depicted in FIG. 2.

As depicted in FIG. 2, the display 400 of the wireless terminal of the invention is divided into two large portions, i.e., a letter input area 420 for displaying the letters typed in by a user, and a retrieved word area 440 for displaying the retrieved words searched using the first and last letters. Here, since the letter input area 420 is similar to the input display area of a conventional cellular phone, details on the letter input area 420 will not be described, and the retrieved word area 440 will be explained in detail below.

The words displayed at the retrieved word area 440 include the same first and last letters as a first letter 422 and a last letter 426 typed-in by a user. However, the displayed words are not alphabetically searched in a conventional manner. For example, if a word to be input is ‘abaculus’, the first letter ‘a’ towards the last letter ‘s’ are not typed in sequentially according to the conventional way, but the first letter ‘a’ and the last letter ‘s’ are input and a function key (e.g. #) is pressed. Then, words having the first letter 422 and the last letter 426, i.e., ‘abaculus’ and ‘abacus’ are retrieved from the word repository 300 and displayed in the retrieved word area 440, as shown in FIG. 3.

Preferably, the cursor 424 is adapted to move in front of the last letter ‘s’ and thus be ready to further type in other letters between the first letter 422 and the letter 426. Therefore, when too many words matching the first letter 422 and the last letter 426 are displayed in the retrieved word area 440, the cursor 424 can input more letters in sequence between the first letter 422 and the letter 426 (i.e., b, a, c, u, l, and u). That is, although the above embodiment illustrates an example of typing-in the first and last letters only, at least the first letter (i.e., ‘aba’ in case of inputting ‘abaculus’) and the last letter (i.e., ‘s’) may be typed in before pressing the function key.

In addition, the number of letters in the words to be retrieved may be limited to a certain predetermined range. That is, in order to speed up the retrieval, for example, a word having less than 5 letters are searched in the same way as the conventional one, i.e., by inputting the letters in alphabetical order, whereas a word having more than 6 letters or 6 to 10 letters is retrieved according to the invention, i.e., by inputting at least the first and last letters of the word. That is, the method of the invention may be categorized into a case of less than 5 letters and a case of more than 6 letters, thereby enabling a faster search and retrieval of words and consequently a faster input of words into a wireless terminal and the like.

In connection with the above matters, a method has been proposed according to the invention, in which a specific function key is designated in order to implement the above-described categorization when inputting letters using a wireless terminal (a cellular phone, a PDA, etc.). For example, if the designated function key is not pressed, only the words having less than 5 letters are input and searched alphabetically in the conventional way. On the other hand, when the designated function key is pressed, the words having a predetermined number of letter, for example more than 6 letters or 6 to 10 letters, are retrieved by means of the first and last letter input method as previously described.

In this way, with the method of inputting letters in accordance with the invention, at least the first letter and the last letter of the word to input are typed in and a function key is pressed, in order to input the desired word into a wireless terminal and the like.

In another embodiment, when the function key is pressed plural times, the length of the last letters may be changed accordingly. For example, if the function key is pressed twice after inputting ‘abus’ (i.e., ab|us), the cursor moves to before the second letter from the last, and ‘us’ is recognized as the last letters. In this way, if the function key is pressed N times, all the letters between the n^{th} letter (n is the same number as N) from the last and the last letter can be recognized as the last letters.

In addition, since the words displayed in the retrieve word area 440 may be displayed in the sequence of higher frequency, a user can select a word more easily. I.e., among the retrieved words, a word ever selected by a user can be displayed above other words, when they are retrieved from the word repository 300.

Referring to FIG. 4, a method of inputting letters into a wireless terminal according to the invention is described in detail below.

As depicted in FIG. 4, if a user types in the first and last letters of a word to input (S100), and presses the function key (S200), the words having the same first and last letters as the typed-in letters are retrieved from the word repository 300(S300).

Here, the above function key may perform three functions: 1) the function for recognizing the letter typed prior to the function key input as the last letter, 2) the function for moving the cursor in front of the typed-in last letter, and 3) the function for retrieving the words consisting of a certain predetermined number of letters. The cursor is moved in front of the typed-in last letter so that more letters can be typed in between the first letter and last letters, when required.

Next, in case where only a few words are retrieved and displayed, additional letters do not need to be typed in between the first and last letters (S400), so that the desired word can be selected from the retrieved and displayed words (S500). Arrow keys and a confirmation key can be used to browse and select the retrieved words. While the retrieved words are browsed, the desired word can be selected and replaced by pressing a key, for instance, the numeric key ‘0’.

When the desired word is selected from the retrieved words, the unfinished word (i.e., only the first and last letters) displayed in the letter input area 420 is changed into the word selected from the retrieved word area 440, thereby forming a complete word, i.e., the word to be input (S600). At this time, the cursor automatically moves to the right end of the word, allowing the next letter to be typed in, i.e., enabling the next word to be input.

At the step S400, if too many words are retrieved by means of the first and last letters only, the number of the retrieved words may be minimized by further inputting letters between the first and last letters. When an adequate number of words are displayed, the further input of letters is stopped and the desired word is selected from the retrieved and displayed words (S400, S700). For example, in case where a word ‘adornment’ is intended to input, if the retrieved words ‘adornment, advancement, etc.’ are displayed in the retrieved word area 440, the second letter ‘d’ can be typed in the state that ‘at’ has been typed-in. If too many words still are retrieved, a user can type in the third letter ‘o’ (i.e., ‘adot’) and select a word from the minimized number of retrieved words. Here, if the third letter ‘o’ is typed in, the word ‘advancement’ will be excluded from the retrieved words, since the third letter of ‘advancement’ is not ‘o’ but ‘v’. As described above, when the typed-in first and last letters generate too many retrieved words, the number of retrieved words can be minimized by further typing letters between the first and last letters.

A modified embodiment, in which the method of inputting letters is applied to a documentation program, is explained below.

As shown FIG. 5, according to the invention, a method of inputting letters also can be applied to a documentation program (e.g. ‘Word 2000’ of Microsoft, ‘Hangul 2002’ of Haansoft.) That is, a retrieved word area 720 is allocated as a portion of a documentation window 700, and a user can select a word from the retrieved word area 720 while preparing a document, or word-processing.

### INDUSTRIAL APPLICABILITY

As described above, according to the invention, without necessity of typing in all the letters of a word, the word can be input in a faster way by simply typing in at least a first letter and a last letter thereof, preferably only the first and last letters.

While the invention has been described with reference to several preferred embodiments, the description is illustrative of the invention and is not to be constructed as limiting the invention. Various modifications and variations may occur to those skilled in the art without departing from the scope and spirits of the invention as defined by the appended claims.

For example, although the invention has been explained by illustrating the input of English words, it will be understood to those skilled in the art that it can be applied to other languages. Further, although the invention is exemplified by a word input by using the first and last letters of the word, a Korean sentence can also be input by typing in the first and last letters of the sentence in Korean language. For example, in order to input a Korean sentence “ [symbol] ”, the sentence “ [symbol] ” can be retrieved by typing in the first letter “ [symbol] ” and the last letter “ [symbol] ”, and then pressing a function key.

Furthermore, while the invention has been explained in conjunction with a wireless terminal, those skilled in the art will readily understand that the invention is not limited to the wireless terminal, but applied to all the devices capable of accepting letters as input, including a cellular phone, a PDA, a PC, a remote controller, and the like.

What is claimed is:

1. A method of inputting letters in a wireless terminal comprising steps of:
a) typing in at least a first and last letters of a word to be input, and pressing a function key;
b) recognizing as the last letter of the word to be input a letter typed-in prior to pressing the function key;
c) from a word repository, retrieving words having the same first and last letters as the typed-in first and last ones and displaying the retrieved words on a display device; and
d) selecting a desired word from the displayed words, and converting the typed-in first and last letters into the selected word.

2. A method according to claim 1, wherein, in the step c), the number of letters of a word to be retrieved is restricted to within a certain predetermined range.

3. A method according to claim 1, wherein a cursor moves in front of the last letter so as to enable an additional letter to be input.

4. A method according to claim 1, wherein the retrieved words is displayed in a sequence of higher retrieval-frequency.

5. A method according to claim 1, wherein, if the function key is pressed N times after typing the last letter, all the letters from the n^{th} letter to the last one are recognized as the last letters.

6. A method of inputting letters in a device capable of accepting letters as input comprising steps of:
a) typing in a first predetermined number of letters sequentially from a first letter of a word to be input, and pressing a function key;
b) retrieving words starting with the typed-in letters, the retrieved words being composed of a second predetermined number of letters;
c) displaying the retrieved words on a display device; and
d) selecting a desired word from the displayed words, and converting the typed-in letters into the selected word.

7. A method according to claim 6, wherein the device includes a cellular phone, a PDA, or a personal computer.
